(19) United States
(12) Patent Application Publication
(10) Pub. No.: US 2006/0165315 A1
(43) Pub. Date: Jul. 27, 2006

(54) Method and apparatus for depth ordering of digital images

(76) Inventors: Fabian E Ernst, Eindhoven (NL); Christiaan Varekamp, Eindhoven (NL); Piotr Wilinski, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/541,053

(22) PCT Filed: Jan. 5, 2004
(86) PCT No.: PCT/IB04/00017

§ 371 Date: Jun. 29, 2005

Related U.S. Application Data
(60) Provisional application No. 60/438,215, filed on Jan. 6, 2003.

(51) Int. Cl. G06K 9/54; G06K 9/00

(52) U.S. Cl. 382/302; 382/106

(57) ABSTRACT

In a method for relative depth of parts of one or more digital images, the digital images are regularized by segmentation, and at least part of the pixels of the images are assigned to respective segments. The realtive motion of the segments for successive images is estimated by image matching. The image features of the segments are regularized by dual segmetation, in which the edges of the segments are found, pixels are assigned to the edges, and dual segments are defined. The relative motion of the dual segments for successive images is estimated by image segment matching in order to determine the relative depth order of the image segments.

The present invention relates generally to the art of video and image processing. It particularly relates to depth ordering within frames of a video sequence based on motion estimation and will be described with particular reference thereto.

For various video sequence processing applications, the motion or the depth order of parts of an image need to be found. Such applications include, for example, scan-rate up-conversion, MPEG coding, and motion-based depth estimation, and many of these applications require computational simplicity. Known methods of motion estimation are based on a matching approach. With such a method, each video frame is partitioned into segments. Then, for each element of the partition (or: segment), a motion vector is estimated such that the amount of dissimilarity or “match penalty” between the shifted version of that segment in the current frame and its location in the following frame is minimized.

More particularly, in known methods of motion estimation and motion-based depth estimation, a motion vector Δx=(Δx,Δy) or a depth d is assigned to a part of the image as a result of minimizing a match error E over a limited set of candidate motion or depth values. It is assumed that the candidate values sample the graph of E as a function of the depth d or motion vector Δx sufficiently dense. Moreover, it is assumed that this graph has a sufficiently prominent global minimum.

While the basic algorithm partitions the image into square blocks, (recent) research has been devoted to partitioning the image into regions with arbitrary geometry, so-called segments, where the segment boundaries are aligned with luminosity or color discontinuities. In this way, segments can be interpreted as being parts of objects in the scene. This can improve the resolution and accuracy of the motion or depth field.

In the typical process of segment-based depth reconstruction out of video sequences, two processing steps are performed after having found a motion vector per segment. The first step is camera calibration, which results in the camera position and orientation. The second step is depth estimation from two subsequent frames, resulting in a per pixel depth estimate. These processing steps may be integrated.

In this depth estimation algorithm, camera calibration is required to enable the conversion of an apparent motion to a depth value. Camera calibration relates to the internal geometric and optical characteristics of the camera and the 3-D position and orientation of the cameras frame relative to a certain world coordinate system. Camera calibration is, however, an unstable procedure. Moreover, current technology for the conversion of motion to camera parameters and depth can only be done if a scene is static. Thus, the known depth estimation algorithms are of limited use if there is not much depth difference in the scene or when objects have their own motion relative to the remainder of the scene.

Further, it is known that depth order may be derived by comparing the motion of a region with the motion of its boundary. Recent methods have tried to solve this segmentation and depth ordering problem simultaneously. One such method is to locate regions and edges in the image, partition the edges into sets, and label the regions, as described in “Edge Tracking for Motion Segmentation and Depth Ordering,” P. Smith, T. Drummond, R. Cipolla, Proceedings of the British Machine Vision Conference, Vol. 2, Pages 369-378, September 1999. Another such method is color segmentation and motion estimation, motion assignment, motion refinement, and region linking, as disclosed in “Integrated Segmentation and Depth Ordering of Motion Layers in Image Sequences,” D. Tweed and A. Calway, Proceedings of the British Machine Vision Conference, pages 322-331, September 2000.

However, the two methods mentioned above have limited applicability because in the first, only two depth layers are feasible, and in both methods a rather complicated global optimization is used.

The present invention is different in that it operates locally and compares the match error between region pairs to obtain a depth ordering. It represents an improvement in that it is based solely on the motion vectors, which does not require camera calibration, and it is valid for any number of depth layers. Further, no threshold is introduced.

According to one aspect of the invention, an apparatus for depth ordering of parts of one or more images, based on two or more digital images, is provided. An input section is provided for receiving the digital images. A first regularization means is provided for regularizing image features of the digital images, composed of pixels, by segmentation, and includes an assigning means for assigning at least part of the pixels of the images to respective segments. A first estimating means is provided for estimating relative motion of the segments for successive images by image matching. A second regularization means is provided for regularizing image features of the segments by dual segmentation and includes a means for finding the edges of the segments, an assigning means for assigning pixels to the edges, and a means for defining dual segments. A second estimating means is provided for estimating relative motion of the dual segments for successive images by image segment matching to determine relative depth order of segments of the images. An output section is provided for outputting relative depth ordering of parts of the images.

According to another aspect of the invention, a method for depth ordering of parts of one or more images using two or more digital images is provided. Image features of the digital images, which are composed of pixels, are regularized by segmentation, and at least parts of the pixels of the images are assigned to respective segments. The relative motion of the segments for successive images is estimated by image matching. The image features of the segments are regularized by dual segmentation, which includes finding the edges of the segments, assigning pixels to the edges, and defining dual segments. The relative motion of the dual segments for successive images is estimated by image segment matching to determine relative depth order of parts of the images.

One advantage of the present invention resides in improving the manner in which relative depth order of digital images from successive frames in a video sequence is determined.

Another advantage of the present invention resides in being able to determine relative depth order without requiring camera calibration.

Yet another advantage of the present invention resides in being able to determine relative depth order for more than two depth layers in a digital image.

Yet another advantage of the present invention resides in improving the accuracy of the motion vector estimate.

Numerous additional advantages and benefits of the present invention will become apparent to those of ordinary skill in the art upon reading the following detailed description of the preferred embodiment.

The invention may take form in various components and arrangements of components, and in various steps and arrangements of steps. The drawings are only for the purpose of illustrating preferred embodiments and are not to be considered as limiting the invention.

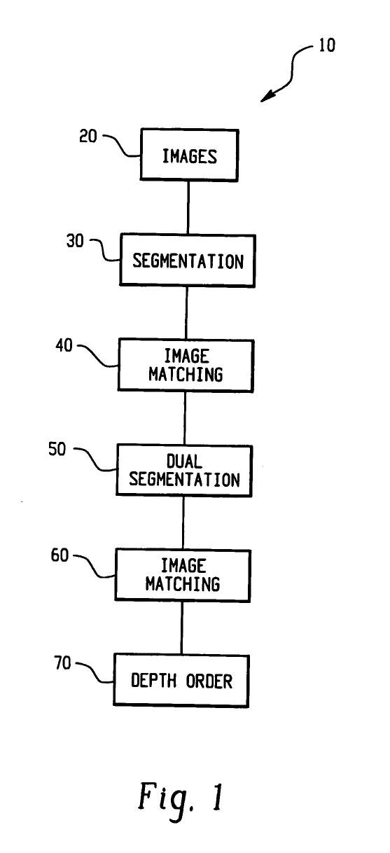

FIG. 1 illustrates an example of a process for depth ordering of parts of digital images based on motion estimation.

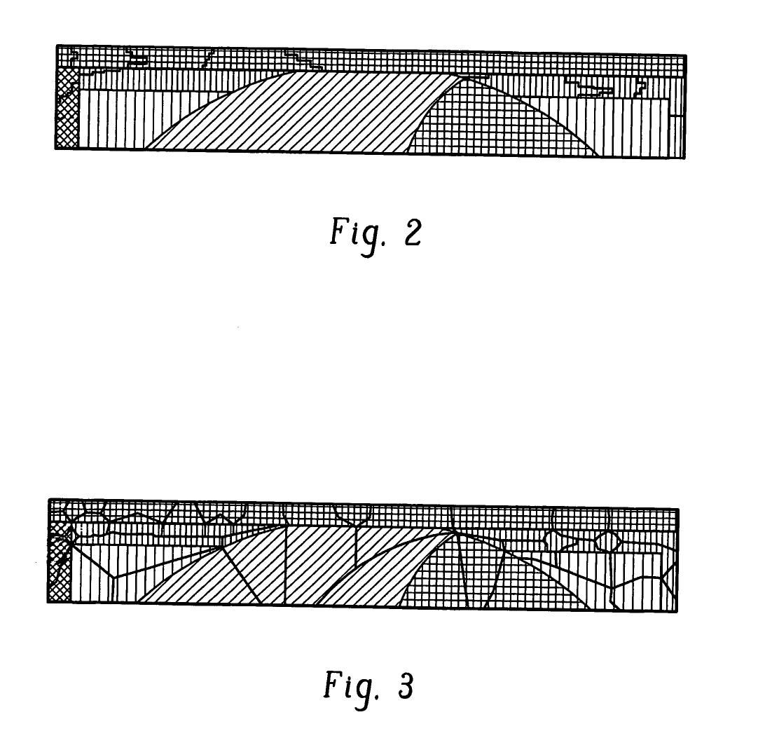

FIG. 2 illustrates an example of an original segmentation of a portion of a frame from the Doll House sequence.

FIG. 3 illustrates an example of a dual segmentation of a portion of a frame from the Doll House sequence.

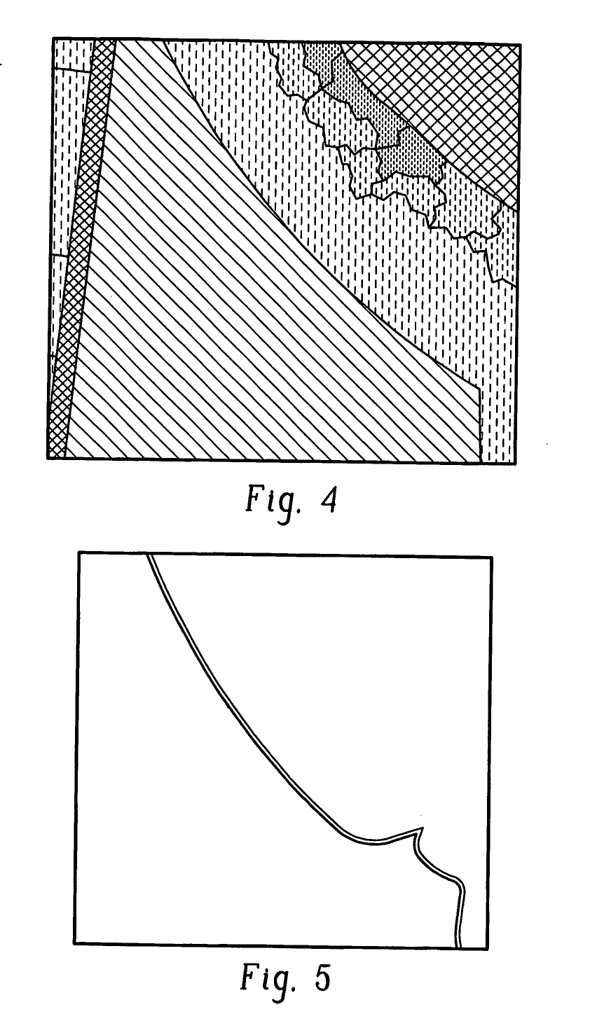

FIG. 4 illustrates an example of an original segmentation of a portion of a frame from the Dionysios sequence.

FIG. 5 illustrates an example of depth ordering of a portion of a frame from the Dionysios sequence.

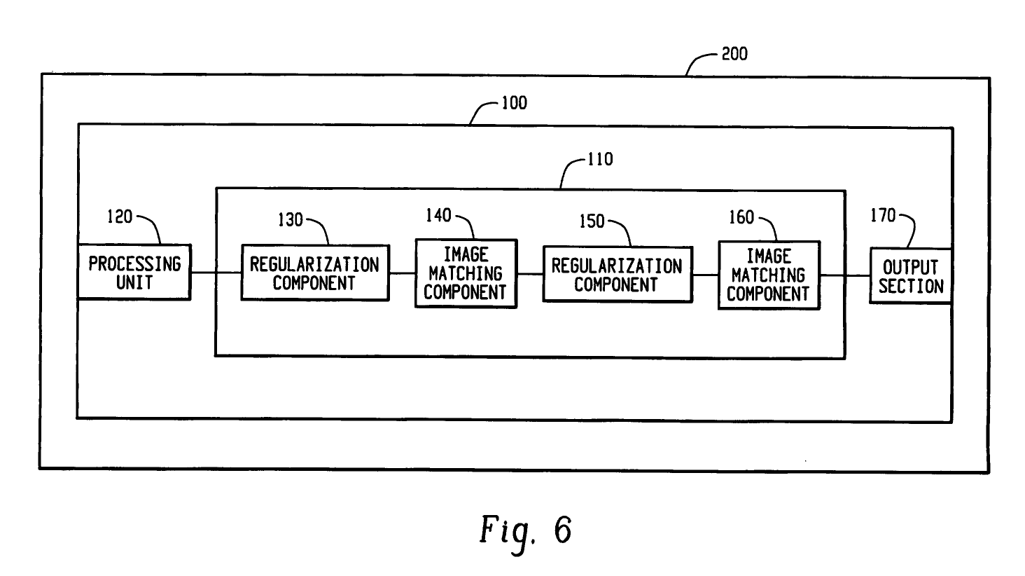

FIG. 6 schematically shows a device for depth ordering of parts of digital images.

In the following preferred embodiment, a process for determining depth order relationships of parts of digital images is explained. These images can be subsequent images from a video stream, but the depth order process is not limited thereto.

With reference to FIG. 1, a process 10 depth orders parts of images 20 within a frame. A first step 30 of the process 10 is segmentation of the images 20 in the frames. A second step 40 is determining matching sections in subsequent segmented images from the video stream. A third step 50 is dual segmentation of the images 20. A fourth step 60 is determining the motion of dual segments of the image through image segment matching. An output 70 is relative depth orders of the parts of the images 20.

The images 20 are digital images consisting of image pixels and defined as two 2-dimensional digital images I₁(x, y) and I₂(x, y), wherein x and y are the coordinates indicating the individual pixels of the images. The process 10 includes the calculation of a pair of functions: M=Δx(x, y) and M=Δx(x, y). M is defined such that every pixel in the image I₁ is mapped to a pixel in image I₂ according to the formula:
I₂(x,y)=I₁(x+Δx(x,y), y+Δy(x,y)).
The construction of M is modified by redefining M as a function that is constant for groups of pixels having a similar motion.

A collection of pixels for which M is said to be constant is composed of pixels that are suspected of having a similar motion. To find such collections, the images 15 are divided into segments by means of the segmentation step 30. Image I₁ is thus divided into segments consisting of pixels that are bounded by borders, which define the respective segments. Segmentation of an image amounts to deciding, for every pixel in an image, the membership to one of a finite set of segments, where a segment is a connected collection of pixels. Image segmentation methods can be generally divided into feature-based and region-based methods. With respect to the depth ordering process 10, the type of image segmentation used should, at a minimum, identify the motion discontinuities. It is assumed that motion and color discontinuities coincide, which means that the segmentation algorithm preferably puts segment borders at color boundaries. However, it may also put segment boundaries elsewhere. As this is one of the major purposes of image segmentation, the particular choice of color-based image segmentation algorithm is not crucial to the present depth ordering process. FIG. 2 shows a frame from the Doll House sequence that has undergone color boundary segmentation.

The second step 40 of the process 10 is image matching, or segment-based motion estimation. More particularly to the preferred embodiment, the second step 40 includes a determination of the displacement function M for a segment between image I₁ and image I₂, whereby a projection of the segment in the image I₂ needs to be found that matches the segment to produce M. This is done by selecting a number of possible match candidates of image I₂ for the match with the segment, calculating a matching criterion for each candidate, and then selecting the candidate with the best matching result. The matching criterion is a measure of the certainty that the segment of the first image matches with a projection in the second image. To determine which of the candidate projections matches best with the segment, a matching criterion is calculated for each projection. The matching criterion is used in digital imaging processing and is known in its implementation as minimizing a matching error or matching penalty function. Such functions and methods of matching by minimizing a matching function are known in the art.

Accordingly, with a segment and a candidate motion vector the location of the pixels of the segment in the next image is predicted. Thus, in the second step 30, a comparison is made of the predicted pixel colors with the actual colors observed in the second image. The difference between the predicted and the actual colors is summarized and called the match penalty or “SAD error.” (SAD is an acronym for the Sum of Absolute Difference.) Finally, the candidate motion vector which has the smallest match penalty is assigned to each segment. To do this efficiently, smart choices for the candidate motion vectors are preferably made (for instance, the optimal motion vector of a neighboring segment), but this aspect is not crucial to the invention.

The third step 50 in the depth ordering process 10 is the defining of a dual segmentation for each image. As stated earlier, segmentation of an image amounts to deciding for every pixel in the image, the membership to one of a finite set of segments, where a segment is a connected collection of pixels. A particularly advantageous method of the dual segmentation is the so-called “quasi segmentation” method. In the quasi segmentation method, so called “seeds” of segments are grown by means of distance transform such that at least parts of the pixels are assigned to a seed. This results in significantly decreased calculation costs and increased calculation speeds. The quasi segments can thus be used in matching of segments in subsequent images.

The dual segmentation step 50 consists of two components: finding the edges of the segments and assigning pixels to the segments. Thus, based on the original segmentation, for each pair of segments (Sᵢ, Sⱼ), all edge pixels are labeled with a number eᵢⱼ, i.e., those pixels p for which p ε Sᵢ and ∃q ε N₄(p) such that q ε Sᵢ, and those for which p ε Sⱼ and ∃q ε N₄(p) such that q ε Sⱼ, where N₄ denotes the 4-neighborhood of p. The dual segment Sᵢⱼ is now created, whereby the seed corresponds to the edge pixels eᵢⱼ. A seed consists of seed pixels, wherein seed pixels are the pixels of the image that are closest to the hard border sections. The seeds form an approximation of the border sections within the digital image pixel array; as the seeds fit within the pixel array, subsequent calculations can be performed easily. Seed pixels are defined all along the detected border between the two segments, giving rise to two-pixel wide double chains. The chain of seed pixels along the border—in this case, both sides are part of the SAME seed—is regarded as a seed and indicated by a unique identifier. As a result of edge detection, the seed pixels essentially form chains. Seeds can also be arbitrarily shaped clusters of edge pixels, in particular seeds having a width of more than a single pixel. A distance transform gives, for every pixel (x, y), the shortest distance d(x, y) to the nearest seed point. Any suitable definition for the distance can be used, such as the Euclidean, “city block” or “chessboard” distance. Methods for calculating the distance to the nearest seed point for each pixel are known in the art, and in implementing the process 10 any suitable method can be used.

The algorithm that is used is in the preferred embodiment is based on two passes over all pixels in the image I(x, y), resulting in values for d(x, y) indicating the distance to the closest seed. The values for d(x, y) are initialized. In the first pass, from the upper left to lower right of image I, the value d(x, y) is set equal to the minimum of itself and each of its neighbors plus the distance to get to that neighbor. In a second pass, the same procedure is followed while the pixels are scanned from the lower right to upper left of the image I. After these two passes, all d(x, y) have their correct values, representing the closest distance to the nearest seed point.

During the two passes where the d(x, y) distance array is filled with the correct values, the item buffer b(x, y) is updated with the identification of the closest seed for each of the pixels (x, y). After the distance transformation, the item buffer b(x, y) has for each pixel (x, y) the value associated with the closest seed. This results in the digital image being segmented; the segments are formed by pixels (x, y) with identical values b(x, y). Thus, part of the segments to both sides of the edge form a dual segment. This aspect is best seen FIGS. 2 and 3, which feature a portion of a frame from the Doll House sequence. Depicted in these figures is an arch. In FIG. 2, the original segmentation, the arch consists of black and grey segments, which are separated by the edge. In FIG. 3, a dual segmentation exists that is partly in the black part, partly in the grey part, and consists of those pixels that are closer to the edge between the two parts in the original segmentation than to any other edge in the original segmentation.

The fourth step 60 in the process 10 is to compute the match penalties for each of the dual segments for two candidates. Each border of the original segmentation gives rise to a segment in the dual segmentation. Since there is now a dual segmentation, image matching is once again undertaken. However, to make the process faster and more efficient in this step, only two candidates for each border are used—the optimal motion vector for the segments on both sides of the border. These are the motion vectors that minimize the match penalty.

Thus, in the preferred embodiment, the two candidates for segment Sᵢⱼ are the optimal motion vectors between the two or more images or frames for the original segments Sᵢ and Sⱼ. The corresponding match penalties are called Mᵢ and Mⱼ. After the match penalties are determined, it is decided which segment is the closer one, or the output 70. This task is accomplished by comparing Mᵢ to Mⱼ. If Mᵢ is less than Mⱼ, then Sᵢ is the closer segment. Likewise, if Mᵢ is greater than Mⱼ, then Sⱼ is the closer segment. Thus, the likelihood that a correct determination has been made can be given in terms of the difference Mᵢ−M_{j.}

To explain why this improved depth ordering process 10 works, it is noted that an edge is characterized by a relatively large color contrast relative to the texture within a segment by the definition of the segmentation. The edge (or the color contrast) has the same motion as the closer segment: the edge belongs to that segment. For the farther segment, pixels are included below the other segment, and the movement of the edge is not related to the movement of the segment. The match penalty is sensitive to the color contrast; thus, it will be lowest for the motion vector that corresponds to the motion of the closer segment.

FIGS. 4 and 5 illustrate the results of the depth ordering method for a portion of a pair of frames of the Dionysios sequence at slightly shifted camera positions. Depth contrasts are encoded in FIG. 5 as black/white edges, where the light part is the upper side and the dark part the lower side. The size of the contrast indicates the difference in match penalty, or the confidence in the depth ordering. It can be seen that the foreground and the background are ordered adequately.

As an alternative embodiment of the invention, it is possible to do full image matching (or motion estimation) for the dual segmentation and only test a limited number of candidates (e.g., the optimal motion vectors of all the edges surrounding a segment) for the original segments.

One of the advantages of the depth ordering process 10 includes the fact that the extra computational expenses are relatively small. The dual segmentation consists of a distance transform, which can be implemented as a two-pass operation over the digital image and only two candidate motion vectors have to be evaluated for the segment. This can be made even cheaper by matching only in a small region (e.g., 4 pixels wide) around the edge and not for the full dual segment.

The depth order of segments may also be used in the RANSAC-based camera calibration algorithm, where parameter estimates that are inconsistent with the derived depth order can be discarded.

A computer program product including computer program code sections for performing the above steps can be stored on a suitable information carrier such as a hard or floppy disc or CD-ROM or stored in a memory section of a computer. It may also be directly implemented in specific or reconfigurable hardware.

With reference to FIG. 6, a device 100 for depth ordering of digital images includes a processing unit 120 for depth ordering of parts of digital images according to the method as described above. The processing unit 120 includes a first regularization component 130 for segmentation of the images, a first image matching component 140 for estimating motion of the segments, a second regularization component 150 for dual segmentation of the images, and a second image matching component 160. The processing unit 120 is connected with an input section 110 by which digital images are received and put through to the processing unit 120. The processing unit 120 is further connected to an output section 170 through which the resulting relative depth order of parts of the digital images is output. The device 100 may be included in a display apparatus 200, such as a 3-dimensional television product.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. An apparatus (100) for depth ordering of parts of one or more digital images comprising:
an input section (110) for receiving the digital images;
a first regularization means (130) for regularizing image features of the digital images, composed of pixels, by segmentation, including assigning means (130) for assigning at least part of the pixels of the images to respective segments;
a first estimating means (140) for estimating relative motion of the segments for successive images by image matching;
a second regularization means (150) for regularizing image features of the segments by dual segmentation, including a means (150) for finding the edges of the segments, an assigning means (150) for assigning pixels to the edges, and a means (150) for creating dual segments;
a second estimating means (160) for estimating relative motion of the dual segments for successive images by image segment matching to determine relative depth order of the image segments.
an output section (170) for outputting relative depth ordering of parts of the images.

2. The apparatus (100) for depth ordering of parts of one or more digital images as set forth in claim 1, wherein the digital images include frames of a two-dimensional video sequence.

3. The apparatus (100) for depth ordering of parts of one or more digital images as set forth in claim 1, wherein the first estimating means (140) includes
a defining means (140) for defining a finite set of candidate values wherein a candidate value represents a candidate for a possible match between image features of two or more images;
an establishing means (140) for establishing a matching penalty function for evaluation of the candidate values;
a selecting means (140) for selecting a candidate value based on the result of the evaluation of the matching penalty function.

4. The apparatus (100) for depth ordering of parts of one or more digital images as set forth in claim 1, wherein the dual segments are defined by taking a pixel along the border of two neighboring segments as seed pixels, and assigning parts of the remaining pixels to one of the seeds using a distance transform algorithm.

5. The apparatus (100) for depth ordering of parts of one or more digital images as set forth in claim 1, wherein the second estimating means (160) includes
a calculating means (160) for calculating optimal motion vectors for the dual segments;
a computing means (160) for computing match penalties for the dual segments;
a selecting means (160) for selecting a closer segment by comparing the optimal motion vectors.

6. A display apparatus (200) comprising the apparatus (100) as set forth in claim 1.

7. A method for relative depth ordering of parts of one or more digital images, the method including:
providing one or more digital images;
regularizing image features of the digital images, composed of pixels, by segmentation, including assigning at least part of the pixels of the images to respective segments;
estimating relative motion of the segments for successive images by image matching;
further regularizing image features of the segments by dual segmentation, including finding the edges of the segments, assigning pixels to the segments, and defining dual segments;
estimating relative motion of the borders of the dual segments for successive images by image segment matching to determine relative depth order of parts of the images.

8. The method for depth ordering of parts of one or more digital images as set forth in claim 7, wherein the digital images include frames of a two-dimensional video sequence.

9. The method for depth ordering of parts of one or more digital images as set forth in claim 7, wherein estimating the relative motion of the segments includes
defining a finite set of candidate values wherein a candidate value represents a candidate for a possible match between image features of two or more images;
establishing a matching penalty function for evaluation of the candidate values;
selecting the candidate value based on the result of the evaluation of the matching penalty function.

10. The method for depth ordering of parts of one or more digital images as set forth in claim 7, wherein the dual segmentation is achieved by means of quasi segmentation, where for each pair of neighboring segments a seed is defined consisting of those pixels which belong to one of the segments and at least one of its neighbors belongs to the other segment, and where at least parts of the other pixels in the images are assigned to that seed to which their distance is smallest

11. The method for depth ordering of parts of one or more digital images as set forth in claim 7, wherein estimating relative motion of the borders of the dual segments includes
calculating optimal motion vectors for the dual segments;
computing match penalties for the dual segments;
selecting a closer segment by comparing the optimal motion vectors.

12. Computer program for enabling a processor to carry out the method for depth ordering of parts of one or more digital images as set forth in claim 7.

13. Tangible medium carrying the computer program as set forth in claim 12.

14. Specific hardware for enabling a processor to carry out the method for depth ordering of parts of one or more digital images as set forth in claim 7.

15. Reconfigurable hardware for enabling a processor to carry out the method for depth ordering of parts of one or more digital images as set forth in claim 7.
